(19) United States
(12) Patent Application Publication
(10) Pub. No.: US 2008/0086698 A1
(43) Pub. Date: Apr. 10, 2008

(54) Display Information in an Interactive Computing Device

(76) Inventors: Mats Hellman, Karlskrona (SE); Jessica Svensson, Karlskrona (SE)

Correspondence Address: HARRITY SNYDER, L.L.P., 11350 RANDOM HILLS ROAD, SUITE 600, FAIRFAX, VA, 22030, US

(21) Appl. No.: 11/576,667

(22) PCT Filed: Oct. 5, 2005
(86) PCT No.: PCT/GB05/03825

§ 371 Date: Sep. 25, 2007

(30) Foreign Application Priority Data
Oct. 5, 2004 (GB) 0422093.5

(51) Int. Cl. G06F 3/048

(52) U.S. Cl. 715/783

(57) ABSTRACT

An interactive computing device comprises a display (2) includes fish-eye areas (4) and (6) for displaying information concerning a plurality of function items in the form of a list or table. The selection of an item results in an increase in the area of the display used to display the selected item, while leaving the area of the display used by non-selected items unchanged. The selection also results in the presentation within the increased area of the information provided in the list before the item was selected together with additional information pertaining to the selected item; and also results in the presentation within the increased fish-eye area of additional command options and related screen controls applicable only to selected items, rather than to the whole list or the activation of which causes the device to carry out the appropriate action.

This invention relates to the listing of overview information on interactive computing devices, and in particular to an improved method of listing overview information which better provides users with both detailed information and functional options.

It has long been known that there are techniques for managing lists of information on the screens of interactive computing devices which enable the display of more information for specific items on a list where a user has indicated that they have more interest in the information.

The term ‘interactive computing devices’ should be construed to include any device which includes both a screen or other method for displaying information and also a keyboard, keypad, button array, touchscreen or some other method for input such as selecting information; today this includes personal devices such as desktop computer, laptop computers, PDAs, Mobile Telephones, Smartphones, Digital Camera, Digital Music Players as well as many other industrial and domestic devices ranging from ATMs to domestic electrical apparatus (such as washing machines and televisions) to transport mechanisms including such devices, such as motor vehicles (of all forms), trains, boats and planes.

So-called ‘fish-eye’ techniques for focusing on specific items when presenting information has been known for some considerable time. Spence and Apperly introduced the notion of what they referred to as Bifocal Displays in 1982 (see R. Spence and M. Apperly, “Data Base navigation: An Office Environment for the Professional”, Behavior and Information Technology, Vol. 1, No. 1), while in 1986 Furnas described how to calculate the appropriate size and visibility of an item depending on its relevance (see G. Furnas, “Generalized Fisheye Views”, in Mantei, M. and Orbeton, P. (eds.), Human Factors in Computing Systems-III, Proceedings of the CHI '86 Conference, Boston, April 1986).

Typically, items in a list are displayed only with sufficient identification information to enable the user of the device to select the item in which they are interested. Using fish-eye techniques, an extended display appears once a single item in the list is highlighted or selected; this gives additional detailed information on that item, with the remainder of the items in the list still appearing, but with summary identification only.

The advantage of the fish-eye technique is that it not only maximizes the use of the available space on the display when listing data but it also removes any necessity for the user to switch to a different view. This combination of maximum use of the screen with minimum user input is especially useful in situations where screen display is limited and input options are restricted, such as when displaying data on an interactive computing device in the form of a mobile telephone (which has a small screen and restricted input compared to desktop computers).

Many implementations of fish-eye techniques are used simply to view tabular data, and prior art descriptions of the technique do not address the issue that the actions which the user of a device might take are different when a list is displayed with and without an item being selected.

For example, consider the case of a user displaying a list of contacts on a mobile telephone. When a list is first displayed, the options a user might have include the following:
scroll through the list of contacts
search the list of contacts for an entry of interest
select an entry from the list contacts
add an entry to the list of contacts
   However, once an item on the list has been selected, the original actions no longer apply, but the following additional options are likely to become meaningful:
edit the specific entry
delete the specific entry
phone the contact number included in the specific entry
send email or other type of message to the address in the specific entry

On a desktop PC with a large screen and easy menu navigation, it might be considered acceptable for the user to invoke drop-down menus in such circumstances, or to have a menu display with certain items greyed out. But such a solution is not ideal for mobile devices, for which use of the screen area should be optimized and where user input should be minimized (especially for one-handed operation).

Implementations of fish-eye views on portable devices have not addressed this problem; for example, the DateLens Fish-eye calendar interface for the Pocket PC displays the same ‘New, View, Find’ options irrespective of whether items are selected or not (see “DateLens: A fisheye calendar interface for PDAs” Benjamin B. Bederson, Aaron Clamage, Mary P. Czerwinski, George G. Robertson, March 2004, ACM Transactions on Computer-Human Interaction (TOCHI), Volume 11 Issue 1).

Keeping the display of possible actions static is inefficient, because screen real estate is wasted on the display of options that are not always appropriate; it is ineffective, because an additional menu and possible multiple key presses would need to be invoked for any extra options, displayed; and it could be viewed as a bad user interface because it does not adjust itself to what the user would want to do in any circumstance.

Note that these deficiencies of the prior art implementations of fish-eye techniques are applicable to all other devices that need to display lists on small screens; these deficiencies are not limited just to mobile telephones. For instance, when applying fish-eye views to lists of MP3 or other files on music players, or to lists of photographs stored on digital cameras, the same considerations apply.

It is, therefore, an object of this invention to at least alleviate the above problems by allowing the inclusion not only of additional information in the expanded area of the fish-eye screen space, but also of additional command areas.

According to a first aspect of the present invention there is provided an interactive computing device having a display comprising fish-eye areas for displaying information concerning a plurality of items in the form of a list or table, and in which the selection of an item in the list or table
a. results in an increase in the fish-eye area of the display used by the selected item, while leaving the areas of the display used by non-selected items unchanged; and
b. results in the presentation within the increased fish-eye area of the information given in the list before the item was selected together with additional information pertaining to the selected item; and
c. results in the presentation within the increased fish-eye area of additional command options and related screen controls applicable only to selected items, rather than to the whole list or the non-selected items, the selection and activation of which causes the device to carry out the appropriate action.

According to a second aspect of the present invention there is provided a method of operating an interactive computing or other data processing device comprising fish-eye areas for displaying partial identification or other types of information concerning a plurality of items in the form of a list or table, in which the selection of a specific item in the list or table
d. results in an increase in the fish-eye area of the display used by the selected item, while leaving the area of the display used by each of the non-selected items functionally unchanged; and
e. results in the presentation within the increased fish-eye area of the original information given in the list before the item was selected together with additional information pertaining to the selected item, which is normally hidden for non-selected items; and
f. results in the presentation within the increased fish-eye area of additional command options and related screen controls applicable only to selected items, rather than to the whole list or the non-selected items, the selection and activation of which causes the device to carry out the appropriate action.

According to a third aspect of the present invention there is provided an operating system for causing an interactive computing device of the first aspect to operate in accordance with a method of the second aspect.

Embodiments of the present invention will now be described, by way of further example only, with reference to the accompanying drawing, in which:

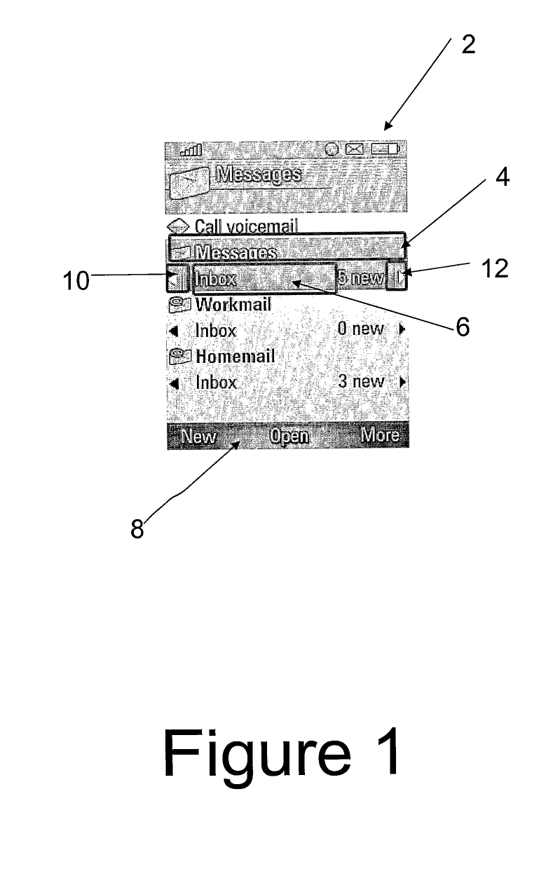

FIG. 1 shows a display screen for an interactive computing device including a fish eye with action areas in accordance with the present invention.

As can be seen in FIG. 1, a display screen 2 for an interactive computing device is used for displaying the commands available to a user for a typical software application loaded on the device: a messaging application in the example shown. The display in the example shown includes fish-eye areas 4 and 6 and a status bar 8. The messaging application can be used by a user to create, send, receive and store various types of messages, such as voice messages (usually referred to as Voicemail) and viewable messages, usually referred to by the term ‘Messages’. The Messages can typically include different types of viewable message, such as SMS (Short Message Service), MMS (Multimedia Message Service) and E-mail, and the application includes a within the ‘Messages’ function an inbox folder (shown in FIG. 1), and an outbox folder (not shown in figurer). Other folders are also available within the application, such as ‘Workmail’ and ‘Homemail’ which assist the user in managing the various types of messages received and messages sent using the device.

In the display screenshot shown in FIG. 1, the fish-eye area 4 is being used to indicate to a user that he/ she is in the ‘Messages’ function within the Messages application, and the fish-eye area 6 is being used to indicate that the user is in the ‘Inbox’ of the ‘Messages’ function. However, with the present invention the areas 4 and 6 include command areas which enable the user to perform or access different functions. For example, the fish-eye area 6 in FIG. 1 includes left and right shift command areas 10 and 12 which, if selected by the user, such as by tapping on the display screen with a stylus, present the user with further available function options from within that fish-eye area, and the options displayed in the status bar 8 may be changed depending on whether a list item is displayed or not as a result of selecting one of the command areas within the fish-eye.

Therefore, it can be seen that the command areas inside the fish-eye area, such as the command areas 10 and 12 within the fish-eye area 6 of FIG. 1, give the user access to those actions that are applicable to the selected item, but which would not be applicable to the list as a whole; examples of such items are included above.

These command areas could be of various types, at the discretion of the designer of the user interface. Familiar common command area types include menus, hotspots, buttons, icons and other interactive screen control. They can be selected, invoked and acted upon in a variety of ways, including:
the tap of a stylus or similar device on a touch sensitive screen of the device
navigating and selecting using a pointing device such as a mouse or joystick
keys on a keypad or keyboard
special user-defined function keys whose use is normally given on a status display somewhere on the display screen.

Where there are too many possible actions to conveniently fit into the fish-eye area, other techniques for avoiding screen clutter may also be used, such as scrolling or hierarchical menu mechanisms within the fish-eye itself.

Furthermore, should a designer of the user interface so wish, the additional entry-specific command areas included in the fish eye could be at the expense of the list-specific commands displayed when no item has been selected, with the valuable screen area normally used for this purpose being reclaimed for list display. This option could, therefore, further maximize the usage of the entire display area, though at the expense of introducing some modality into the application views.

This invention provides, therefore, an interactive computing device which can be operated with greater efficiency and ease of use in comparison to the known forms of such devices. It gives the user of the device fast access to any command option applicable to specific items on a list as appropriate, without either wasting screen space on the display of such command options when they are not appropriate or unduly wasting the time of a user time by requiring them to invoke and navigate entry-specific menus. This is a significant benefit in interactive computing devices having a restricted display area, such as handheld computing devices and mobile phones.

Although the present invention has been described with reference to particular embodiments, it will be appreciated that modifications may be effected whilst remaining within the scope of the present invention as defined by the appended claims.

1. An interactive computing device having a display comprising fish-eye areas for displaying information concerning a plurality of items in the form of a list or table, and in which the selection of an item in the list or table
a. results in an increase in the fish-eye areas of the display used by the selected item, while leaving the areas of the display used by non-selected items unchanged; and
b. results in the presentation within the increased fish-eye area of the information given in the list before the item was selected together with additional information pertaining to the selected item; and
c. results in the presentation within the increased fish-eye area of additional command options and related screen controls applicable only to selected items, rather than to the whole list or the non-selected items, the selection and activation of which causes the device to carry out the appropriate action.

2. A device according to claim 1 in which the selection of a specific item from the list or table or the selection of a command from the options presented in the increased fish-eye area is made by means including but not limited to either
a. tapping or pressing a stylus or other object one or two times on a specific area of a touch screen; or
b. navigating to an area of the display using a pointing device such as a mouse or a joystick and then pressing a button or key one or two times; or
c. navigating to an area of the display using potential buttons (such as cursor, tab, back, PgUp, PgDn, home or end keys) and then pressing an enter or space or other key one or two time; or
d. using special software definable function keys or buttons whose function is displayed either on a status bar on the display or elsewhere on the device;
either as single techniques or in combination.

3. A device according to claim 1 in which the command options in the increased fish-eye areas can be presented in various forms including but not limited to static menus, scrolling menus, cascading or hierarchical menus, hotspots, buttons, and icons, either singly or in combination.

4. A device according to claim 1 in which the command options in the increased fish-eye area can be presented in various forms including but not limited to static menus, scrolling menus, cascading or hierarchical menus, buttons, and icons, either singly or in combination.

5. A method of operating an interactive computing or other data processing device comprising fish-eye areas for displaying partial identification or other types of information concerning a plurality of items in the form of a list or table, in which the selection of a specific item in the list or table
a. results in an increase in the fish-eye area of the display used by the selected item, while leaving the area of the display used by each of the non-selected items functionally unchanged; and
b. results in the presentation within the increased fish-eye area of the original information given in the list before the item was selected together with additional information pertaining to the selected item, which is normally hidden for non-selected items; and
c. results in the presentation within the increased fish-eye area of additional command options and related screen controls applicable only to selected items, rather than to the whole list or the non-selected items, the selection and activation of which causes the device to carry out the appropriate action.

6. A method according to claim 5 in which the selection of a specific item from the list or table or the selection of a command from the options presented in the increased fish-eye area is made by means including but not limited to either
a. tapping or pressing a stylus or other object one or two times on a specific area of a touch screen; or
b. navigating to an area of the display using a pointing device such as a mouse or a joystick and then pressing a button or key one or two times; or
c. navigating to an area of the display using positional buttons (such as cursor, tab, back, PgUp, PgDn, home or end keys) and then pressing an enter or space or other key one or two time; or
d. using special software definable function keys or buttons whose function is displayed either on a status bar on the display or elsewhere on the device;
either as single techniques or in combination.

7. A method according to claim 5 in which the command options in the increased fish-eye area can be presented in various forms including but not limited to static menus, scrolling menus, cascading or hierarchical menus, hotspots, buttons, and icons, either singly or in combination.

8. A method according to claim 5 in which the presentation of command options applicable to either the list or table or non-selected items is removed from the display once a single item from the list is selected, with the free space being used for the display of items that would otherwise have been displayed by increasing the area use by the selected item.

9. An operating system for causing a computing device to operate in accordance with a method as claimed in claim 5.

10. A device according to claim 2 in which the command options in the increased fish-eye areas can be presented in various forms including but not limited to static menus, scrolling menus, cascading or hierarchical menus, hotspots, buttons, and icons, either singly or in combination.

11. A method according to claim 6 in which the command options in the increased fish-eye area can be presented in various forms including but not limited to static menus, scrolling menus, cascading or hierarchical menus, hotspots, buttons, and icons, either singly or in combination.

12. A method according to claim 6 in which the presentation of command options applicable to either the list or table or non-selected items is removed from the display once a single item from the list is selected, with the free space being used for the display of items that would otherwise have been displayed by increasing the area used by the selected item.

13. A method according to claim 7 in which the presentation of command options applicable to either the list or table or non-selected items is removed from the display once a single item from the list is selected, with the free space being used for the display of items that would otherwise have been displayed by increasing the area used by the selected item.

14. An operating system for causing a computing device to operate in accordance with a method as claimed in claim 6.
